(19) United States
(12) Patent Application Publication
(10) Pub. No.: US 2013/0226450 A1
(43) Pub. Date: Aug. 29, 2013

(54) APPARATUS AND METHOD FOR SUPPORTING SAFE NAVIGATION OF SHIPS

(71) Applicants: Jeong-Ho PARK, Daejeon (KR); Byung-Tae JANG, Daejeon (KR); Dong-Sun LIM, Seoul (KR)

(72) Inventors: Jeong-Ho PARK, Daejeon (KR); Byung-Tae JANG, Daejeon (KR); Dong-Sun LIM, Seoul (KR)

(73) Assignee: ELECTRONICS AND ELECOMMUNICATIONS RESEARCH INSTITUTE, Daejeon-City (KR)

(21) Appl. No.: 13/585,358

(22) Filed: Aug. 14, 2012

(30) Foreign Application Priority Data
Feb. 23, 2012 (KR) KR 10-2012-001854

(51) Int. Cl. G01C 21/14

(52) U.S. Cl. 701/431

(57) ABSTRACT

Disclosed is an apparatus and method for supporting the safe navigation of ships based on mobile terminals which can prevent accidents at sea including marine collisions between small ships sailing near the coastline. The method for supporting the safe navigation of a ship in conjunction with a mobile terminal carried by a crew member of a ship includes collecting information about the navigation of the ship by a safe ship navigation supporting apparatus positioned in the ship, collecting information about surrounding ship through group communication with a server corresponding to the surrounding ship, converting a chart transmitted from a ground server into a format compatible with the mobile terminal, and applying safe navigation information created on the basis of the information about the navigation and the information about the ship to the converted chart, and providing the crew member with the safe navigation information through the mobile terminal.

### CROSS-REFERENCE(S) TO RELATED APPLICATIONS

This application claims priority to Korean Patent Application No. 10-2012-0018548, filed on Feb. 23, 2012 which is incorporated herein by reference in its entirety.

### BACKGROUND OF THE INVENTION

1. Field of the Invention

Exemplary embodiments of the present invention relate to an apparatus and method for supporting the safe navigation of ships; and, particularly, to an apparatus and method for supporting the safe navigation of ships based on mobile terminals which can prevent accidents at sea including marine collisions of small ships sailing near the coastline.

2. Description of Related Art

Most marine accidents occur near the coastline, and, in the case of ship collisions, accidents caused by small ships account for 60% or more of al accidents.

In the case of small ships, since they have no equipment such as electronic chart display and information systems (ECDIS) or automatic identification systems (AIS), which are mandatorily fitted on large vessels, other ships cannot know information about the positions or sailing route of small ships. When marine conditions are not good, accidents may occur at sea.

In addition, when identifying the relative positions of ships, there is a problem in that the risk of an accident is further increased because errors that occur during voice communication (VHF communication is usually utilized) and the supply of incorrect navigation route information.

### SUMMARY OF THE INVENTION

An embodiment of the present invention is directed to an apparatus and method for realizing the safe navigation of small ships, which are not equipped with equipment such as ECDIS or AIS, based on a mobile terminal.

Other objects and advantages of the present invention can be understood by the following description, and will become apparent with reference to the embodiments of the present invention. Also, it will be obvious to those skilled in the art to which the present invention pertains that the objects and advantages of the present invention can be realized by the means as claimed and combinations thereof.

In accordance with an embodiment of the present invention, a method for supporting the safe navigation of a ship in conjunction with a mobile terminal carried by a crew member of a ship includes collecting information about navigation of the ship using the safe ship navigation supporting apparatus located on the ship, collecting information about ships surrounding the ship through group communication with a server corresponding to the surrounding ships, converting a chart transmitted from a ground server into a format compatible with the mobile terminal, and applying the safe navigation information created based on the information about the navigation and the information about the ship to the converted chart, and providing the crew member with the safe navigation information through the mobile terminal.

The information about the navigation of the ship may include major information about sailing of the ship, such as the moving velocity of the ship, the trajectory of the ship, the destination of the ship, or the position of the ship.

The collecting information about the navigation of the ship may collect the information about the navigation using a sensor in the ship, or may collect the information about the navigation using GPS information included in the mobile terminal carried by the crew member.

In the converting the chart transmitted from the ground server into the format compatible with the mobile terminal, the chart may be converted into a vector or raster format compatible with the mobile terminal.

In accordance with another embodiment of the present invention, an apparatus for supporting the safe navigation of a ship in conjunction with a mobile terminal carried by a crew member of a ship includes a safe ship navigation supporting apparatus positioned in the ship, including a navigation information managing unit configured to collect information about the navigation of the ship, a chart processing unit configured to convert a chart transmitted from a ground server into a format compatible with the mobile terminal, and a communication control unit configured to collect information of a ship surrounding the ship through group communication with a server corresponding to the surrounding ship, in which the communication control unit applies safe navigation information created based on the information about the navigation and the information about the ship to the converted chart, and provides the crew member with the safe navigation information through the mobile terminal.

The navigation information managing unit may collect the information about the navigation using a sensor in the ship.

The navigation information managing unit may collect the information about the navigation using GPS information included in the mobile terminal carried by the crew member.

The information about the navigation may include a moving velocity of the ship, a trajectory of the ship, a destination of the ship, and a position of the ship.

The chart processing unit may convert the chart into a vector or raster format compatible with the mobile terminal.

With the configuration of the present invention, the safe ship navigation supporting apparatus and the method thereof can be applied to small ships which are hardly equipped with a basic equipment associated with the safe navigation of the ship, thereby offering the ship with the safe navigation by determining the positions of the surrounding ships based on the mobile terminal, and communicating with the ship of interest.

In addition, since the ship of interest shares important information about the surrounding ships, the ship can safely navigate.

### BRIEF DESCRIPTION OF THE DRAWINGS

FIG. 1 is a diagram schematically illustrating environments to which an apparatus for supporting the safe navigation of ships according to an embodiment of the present invention is applied;

FIG. 2 is a diagram illustrating a ground server according to an embodiment of the present invention;

FIG. 3 is a diagram illustrating an apparatus for supporting the safe navigation of ships according to an embodiment of the present invention;

FIG. 4 is a diagram illustrating a mobile terminal according to an embodiment of the present invention;

FIG. 5 is a diagram illustrating a process in which an apparatus for supporting the safe navigation of ships according to an embodiment of the present invention performs group communication between ships using mobile terminals; and

FIG. 6 is a flowchart illustrating a method for supporting the safe navigation of ships according to an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Now, an apparatus and method for supporting the safe navigation of ships according to an embodiment of the present invention will be described in detail with reference to the accompanying drawings.

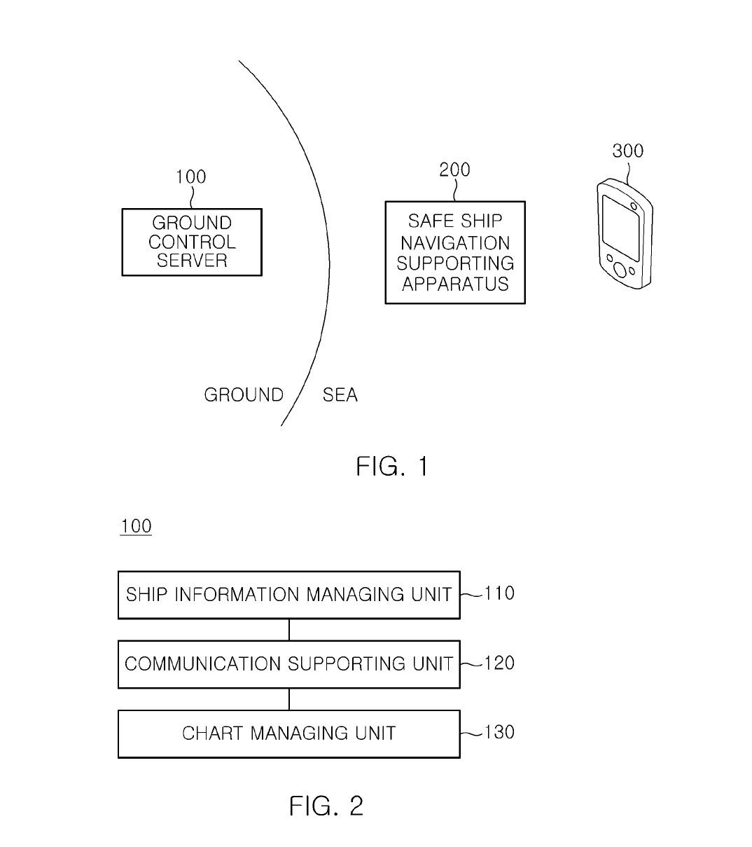

FIG. 1 is a diagram schematically illustrating environments to which the apparatus for supporting the safe navigation of ships according to the embodiment of the present invention is applied.

First, it is assumed that a broadband communication network (above 1 Mbps) such as 3G or HSDPA, or Wi-Fi is available in costal areas which are within a predetermined distance from the shore under the circumstances in which the apparatus for supporting the safe navigation of ships is applied.

Referring to FIG. 1, the circumstances under which the safe ship navigation supporting apparatus according to the embodiment of the present invention is applied includes a ground server 100, a safe ship navigation supporting apparatus 200, and a mobile terminal 300.

The ground server 100 corresponds to a server installed in a ground control center, and transmits and receives various information to and from ships at sea.

The safe ship navigation supporting apparatus 200 transmits and receives the information to and from the ground server 100, or transmits and receives the information to and from the mobile terminal 300 carried by a crew member of the ship, thereby creating information about the safe navigation of the ship. Next, the safe ship navigation supporting apparatus 200 provides the mobile terminal 300 carried by the crew member with the information about the safe navigation of the ship to support the safe navigation of the ship.

The safe ship navigation supporting apparatus 200 according to the embodiment of the present invention may be a ship server positioned in the ship, but the present invention is not limited thereto.

The mobile terminal 300 is carried by the crew member of the ship, and corresponds to, for example, a smart phone such as an iPhone or a Galaxy phone, or a portable terminal such as an iPad or Galaxy Tab.

Next, the ground server 100 will be described in detail with reference to FIG. 2.

FIG. 2 is a diagram illustrating the ground server according to the embodiment of the present invention.

Referring to FIG. 2, the ground server 100 includes a ship information managing unit 110, a communication supporting unit 120, and a chart managing unit 130.

The ship information managing unit 110 manages basic information about respective ships, for example, the name of the ship, the registration number of the ship, the current position of the ship, the sailing route of the ship, and so forth. The ship information managing unit 110 is registered with the information about the ship in advance, or collects and manages the information about the ship from each ship in real time.

The ship information managing unit 110 collects information about other ships in the vicinity of the reference ship at sea, and provides the reference ship with the collected results, so that the reference ship can verify the navigation status of the surrounding ships in real time.

The communication supporting unit 120 provides voice communication based on session initiation protocol (SIP), and supports 1:N communication by binding at least two ships needing voice communication in one group.

The application of the mobile terminal provides a group communication function similar to the communication supporting unit 120 at present, but is structurally different from the communication supporting unit 120 of the present invention. Specifically, in order to perform group communication in the ship, the mobile terminal positioned in the ship transmits the information to the safe ship navigation supporting apparatus 200. The safe ship navigation supporting apparatus 200 transmits the information about the mobile terminal to the ground server 100, and collects the information corresponding to the ship to perform the group communication, and the information of the corresponding mobile terminal. The safe ship navigation supporting apparatus 200 provides a passage to allow voice communication between the ships.

The group communication can solve a problem with existing VHF communication, that is, it does not know the identity of the other communicating ship, or solve a keying phenomenon in which one ship has a monopoly on a VHF communication channel.

The chart managing unit 130 collects and manages charts which are periodically modified by outside institutions, and supplies the chart to ships requiring it.

The chart managing unit 130 according to the embodiment of the present invention supplies the chart to the ship requiring the chart, so that even a small ship that does not mandatorily require the ECDIS can be provided with an environment in which to view the chart using the mobile terminal, instead of the ECDIS.

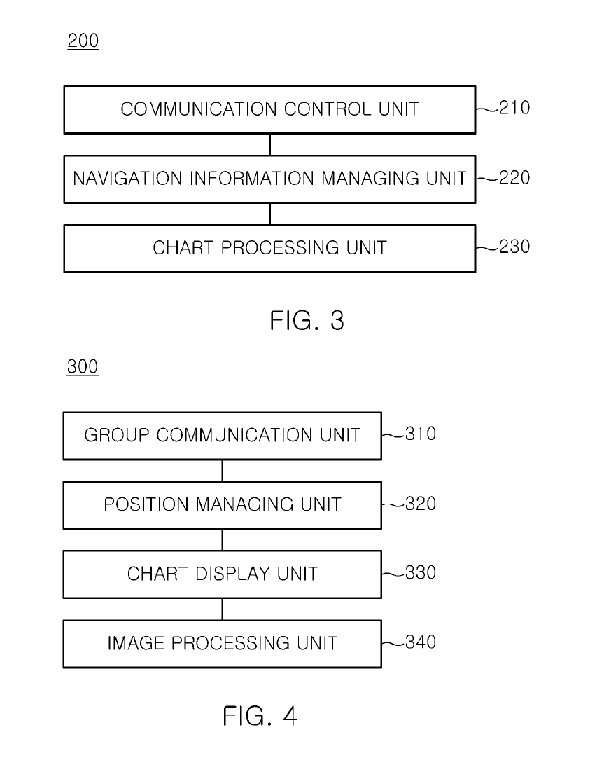

Next, the safe ship navigation supporting apparatus 200 will be described in detail with reference to FIG. 3.

FIG. 3 is a diagram illustrating the safe ship navigation supporting apparatus according to the embodiment of the present invention.

First, the safe ship navigation supporting apparatus 200 is positioned in the ship to support the safe navigation of the ship. Herein, the ship supported by the safe navigation is referred to as a reference ship, and ships positioned in the vicinity of the reference ship are referred to as surrounding ships.

Referring to FIG. 3, the safe ship navigation supporting apparatus 200 includes a communication control unit 210, a navigation information managing unit 220, and a chart processing unit 230.

In the case in which it is necessary to communicate with a server corresponding to the surrounding ship, the communication control unit 210 performs a relay role to perform group communication between the reference ship and the surrounding ships by transmitting a message requesting the group communication received from the mobile terminal 300, or receiving a message in which the ground server 100 accepts the group communication received from a surrounding ship.

The navigation information managing unit 220 collects and manages the information about the navigation, such as the moving velocity of the reference ship, the trajectory of the reference ship, the destination of the reference ship, or the position of the reference ship, through an external sensor. If the navigation information managing unit 220 does not collect the information about the navigation through the external sensor, the navigation information managing unit 220 may collect the information about the navigation using GPS information included in the mobile terminal 300.

In addition, the navigation information managing unit 220 transmits the information of the surrounding ship transmitted from the ground server 100 to the mobile terminal 300.

The chart processing unit 230 converts the chart transmitted from the ground server 100 into a format compatible with the mobile terminal 300, and transmits the converted result to the mobile terminal 300. Herein, the format compatible with the mobile terminal 300 may be a vector or raster, but the present invention is not limited thereto.

Next, the mobile terminal 300 will be described in detail with reference to FIG. 4.

FIG. 4 is a diagram illustrating the mobile terminal according to the embodiment of the present invention.

First, the mobile terminal 300 corresponds to a terminal carried by a crew member of the reference ship, and operates in conjunction with the safe ship navigation supporting apparatus 200 positioned in the reference ship, so that safe ship navigation supporting apparatus 200 can support the safe navigation of the ship.

Referring to FIG. 4, the mobile terminal 300 includes a group communication unit 310, a position managing unit 320, a chart display unit 330, and an image processing unit 340.

The group communication unit 310 selects the surrounding ship requiring the voice communication while the reference ship is sailing, and makes a request to the safe ship navigation supporting apparatus 200 for voice communication with the selected ship near the reference ship. The safe ship navigation supporting apparatus 200 transmits the message requesting the group communication to the surrounding ships via the ground server 100, and receives the message accepting the group communication from the surroundings ships, thereby operating the 1:N group communication. Group communication is a communication method having an emergency transmission function, unlike the VHF communication, which is used to transmit one's intentions to other ships.

The position managing unit 320 transmits GPS information corresponding to the mobile terminal, for example, information about the velocity, position, and direction of the ship carrying the mobile terminal 300, to the safe ship navigation supporting apparatus 200, or transmits the information of the surrounding ships transmitted from the safe ship navigation supporting apparatus 200 to the chart display unit 330.

The chart display unit 330 displays the chart transmitted from the safe ship navigation supporting apparatus 200, and displays the position, trajectory and name of the surrounding ships overlaid with the chart.

The image processing unit 340 converts the environment information (e.g., information about a fire on a ship, an accident involving surrounding ships, or the like) of the reference ship obtained from a camera provided in the mobile terminal 300 into a set format, and transmits the converted result to the ground server 100, so that the ground server 100 can utilize it as materials for detecting an emergency situation.

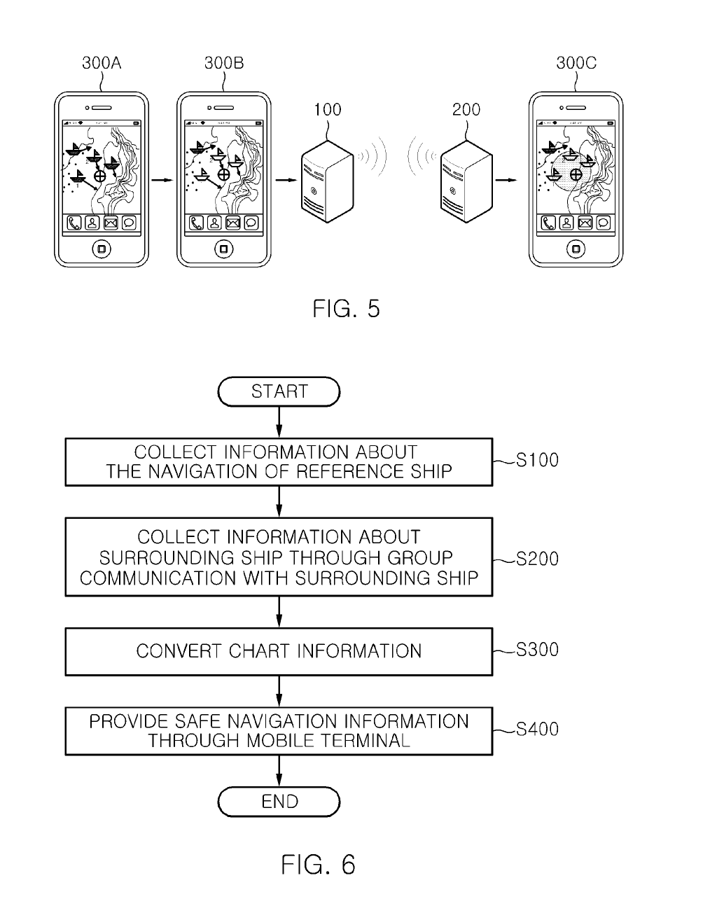

Next, an embodiment in which the safe ship navigation supporting apparatus performs group communication using the mobile terminals will be described in detail with reference to FIG. 5.

FIG. 5 is a diagram illustrating a process in which the safe ship navigation supporting apparatus according to the embodiment of the present invention performs the group communication between the ships using the mobile terminals.

Referring to FIG. 5, mobile terminals 330A to 300C display the chart transmitted from the safe ship navigation supporting apparatus 200, with the surrounding ships overlaid on the chart. The crew member carrying the mobile terminal 300C touches and selects ships requiring attention along the moving route of his or her ship, that is, the reference ship. In this instance, the mobile terminal 300C receives the position of the respective ship and the trajectory and velocity of the respective ship from the ground server 100, so that the ship requiring attention can be automatically selected by a set algorithm.

The safe ship navigation supporting apparatus 200 automatically collects the information about the ships selected by the mobile terminal 300, and transmits it to the ground server 100.

The ground server 100 conducts the relay role for the group communication with the ships of interest after verifying whether the ship selected by the mobile terminal 300 takes part or not. During the group communication, in order to display which ship has the right to speak at the moment, the ground server transmits a sound data stream interpolated with the assigned number of the ship having the right to speak. That is, the ship receiving the sound data can determined which ship the voice is transmitted from, through the display of the mobile terminal. In this instance, the mobile terminal 300B may display the interested ship in a different color or by blinking.

Next, a method for supporting the safe navigation of the ships will be described in detail with reference to FIG. 6.

FIG. 6 is a flowchart illustrating the method for supporting the safe navigation of ships according to an embodiment of the present invention.

First, the safe ship navigation supporting apparatus 200 is positioned in the ship to support the safe navigation of the ship in conjunction with the mobile terminal 100 carried by the crew member of the ship. Herein, the ship supported by the safe navigation is referred to as a reference ship, and ships positioned in the vicinity of the reference ship are referred to as surrounding ships.

Referring to FIG. 6, the safe ship navigation supporting apparatus 200 collects the information about the navigation, such as the moving velocity of the reference ship, the trajectory of the reference ship, the destination of the reference ship, or the position of the reference ship, through an external sensor (step S100). If the safe ship navigation supporting apparatus 200 does not collect the information about the navigation through the external sensor, it may collect the information about the navigation using GPS information included in the mobile terminal 300.

The safe ship navigation supporting apparatus 200 collects the information about the surrounding ships through the group communication with a server corresponding to the surrounding ships (step S200).

The safe ship navigation supporting apparatus 200 converts the chart transmitted from the ground server 100 into a format compatible with the mobile terminal 300 (step S300).

The safe ship navigation supporting apparatus 200 applies the safe navigation information created on the basis of the information about the navigation of the reference ship and the information about the surrounding ships obtained at step S200 to the chart converted at step S300, and provides the crew member with the safe navigation information through the mobile terminal 300 (step S400).

While the present invention has been described with respect to the specific embodiments, it will be apparent to those skilled in the art that various changes and modifications may be made without departing from the spirit and scope of the invention as defined in the following claims.

What is claimed is:

1. A method for supporting safe navigation of a ship in conjunction with a mobile terminal carried by a crew member of a ship, comprising:
collecting information about navigation of the ship using a safe ship navigation supporting apparatus positioned in the ship;
collecting information about a surrounding ship, which is in a vicinity of the ship, through group communication with a server corresponding to the surrounding ship;
converting a chart transmitted from a ground server into a format compatible with the mobile terminal; and
applying safe navigation information created based on the information about the navigation and the information about the surrounding ship to the converted chart, and providing the crew member with the safe navigation information through the mobile terminal.

2. The method for supporting safe navigation of the ship of claim 1, wherein the information about the navigation of the ship comprises major information about sailing of the ship, such as a moving velocity of the ship, a trajectory of the ship, a destination of the ship, or a position of the ship.

3. The method for supporting safe navigation of the ship of claim 1, wherein, in the collecting information about the navigation of the ship, the information about the navigation is collected using a sensor in the ship, or the information about the navigation is collected using GPS information included in the mobile terminal carried by the crew member.

4. The method for supporting safe navigation of the ship of claim 1, wherein in the converting the chart transmitted from the ground server into the format compatible with the mobile terminal, the chart is converted into a vector or raster corresponding to the mobile terminal.

5. An apparatus for supporting safe navigation of a ship in conjunction with a mobile terminal carried by a crew member of a ship, comprising:
a safe ship navigation supporting apparatus positioned in the ship including
a navigation information managing unit configured to collect information about the navigation of the ship;
a chart processing unit configured to convert a chart transmitted from a ground server into a format compatible with the mobile terminal; and
a communication control unit configured to collect information about a surrounding ship, which is in a vicinity of the ship, through group communication with a server corresponding to the surrounding ship,
the communication control unit applying safe navigation information created on the basis of the information about the navigation and the information about the ship to the converted chart, and providing the crew member with the safe navigation information through the mobile terminal.

6. The apparatus for supporting safe navigation of the ship of claim 5, wherein the navigation information managing unit collects the information about the navigation using a sensor in the ship.

7. The apparatus for supporting safe navigation of the ship of claim 5, wherein the navigation information managing unit collects the information about the navigation using GPS information included in the mobile terminal carried by the crew member.

8. The apparatus for supporting safe navigation of the ship of claim 5, wherein the information about the navigation comprises a moving velocity of the ship, a trajectory of the ship, a destination of the ship, and a position of the ship.

9. The apparatus for supporting safe navigation of the ship of claim 5, wherein the chart processing unit converts the chart into a vector or raster corresponding to the mobile terminal.
